(19) United States
(12) Patent Application Publication
(10) Pub. No.: US 2007/0153736 A1
(43) Pub. Date: Jul. 5, 2007

(54) Wireless Handoff to and from an IP Network

(76) Inventors: John Beck Mow, Frisco, TX (US); Raymond Joseph Sheppard, Boca Raton, FL (US)

Correspondence Address: John Beck Mow, 4665 Glen Heather Dr., Frisco, TX, 75034, US

(21) Appl. No.: 11/306,542

(22) Filed: Dec. 31, 2005

(51) Int. Cl. H04Q 7/00

(52) U.S. Cl. 370/331

(57) ABSTRACT

In order to reduce the usage charges of a wireless telephone, the patent will manage and effect a handoff between a subscriber's wireless instrument and the subscriber's IP location, i.e. home, office, etc., and vice versa. The event may be automatically or manually activated without dropping the call. A gateway system linking the IP connection, the wireless connection, the PSTN and/or other networks will be utilized. The subscriber may change their IP location on the fly in a number of ways so this process is not restricted to one IP location.

### FIELD OF THE INVENTION

The present invention relates generally to a handoff scenario between a wireless connection which can be expensive, and a VOIP connection which is far less expensive.

### BACKGROUND OF INVENTION

Typically once a wireless call is made, the call remains wireless until the call is terminated. With the addition of a new method with a gateway linked to an IP network, the wireless call is first made through the gateway in several manners, with the gateway determining how the end point leg of the call is placed, or the gateway receives the call destined to the wireless subscriber instrument and places the call to the wireless service. Likewise the gateway can be instructed to transfer the wireless leg from the gateway to another location where the wireless user is located. A transfer to this destination can be performed, similar to a wireless handoff between wireless switching offices.

The patent utilizes an IP network which can eliminate the costly wireless leg, a server to manage the database and call connection of the IP leg, and a gateway at the edge of the IP network connected to the PSTN and/or other networks, and transfers the call to a IP leg, and vice versa. Another way is to have the gateway coupled with a wireless switching network.

The transfer may be automatically directed to a system typically in the home or office that is on the IP network. The first wireless instrument is either automatically detected through a variety of methods, and the gateway is notified by the server to initiate the transfer to the IP address, or the user manually initiates the process upon arriving at that destination.

The trend by many people is to only have a wireless phone and to utilize it whenever they are at home, traveling, or in the office. If the call could be transferred to an IP connection from the costly cellular/wireless leg, with more and more households and offices are utilizing an IP network today, then there will be cost savings involved. And in many cases the quality of the conversation will be better utilizing a VOIP connection rather than a wireless connection which typically has coverage area problems in residential areas and in office buildings.

A more advanced function is to provide wireless access points with software that would enable recognition of the communication device, such that when the subscriber enters the wireless area, say of a hotel chain or coffee shop, the subscriber ID is recognized by the site, communicating in a manner to have calls forwarded to its IP address for the period of time the subscriber remains there, or have the subscriber initiate the communications. Many people travel with their laptop which can initiate this type of connection allowing the user to utilize a headset as their VOIP telephone.

### PRIOR ART

Different forms of handoff for mobile devices have been in existence for many years, from manual, to cellular to airborne, etc. Today they have a triggering mechanism that is automatically activated. Sometimes the system determines which switch the instrument is best received at, or the instrument may determine this as is the case of one particular airline system. However the handoff is strictly to maintain the mobile leg of the call, not to transfer the leg to another medium such as to an IP network using VOIP.

A PSTN service for subscribers may utilize an adjunct switching system to perform a one number type of service. A transfer or conference to a 3rd party location can be implemented from the mobile phone by dialing particular sequences of DTMF tones, re-establishing the switch back to the dial tone mode, ready to receive commands like in a PBX or Central Office, requiring the mobile user to then dial the destination that it wants to transfer or conference in. But initiating the new leg connection from the home or office PC manually or automatically, with a central IP based server and gateway system as the control elements is not being performed.

No patent research turned up a handoff as described in the patent. Several other types are listed below.

U.S. Pat. No. 6,931,249

Fors, et al. Aug. 16, 2005

Method and apparatus for a target-initiated handoff from a source cellular wireless network to a target non-cellular wireless network.

While this patent covers the handoff between the two wireless networks, cellular and WLAN in a variety of ways, it does not provide for IP to cellular handoff nor allow transfer to a softphone type of connection.

U.S. Pat. No. 6,876,639

Cao Apr. 5, 2005

Transmission Control Protocol Handoff Notification System And Method

U.S. Pat. No. 6,850,503

Dorenbosch, et al. Feb. 1, 2005

Method And Apparatus For Effecting A Handoff Between Two IP Connections For Time Critical Communications

U.S. Pat. No. 6,876,639

Cao Apr. 5, 2005

Transmission Control Protocol Handoff Notification System And Method

U.S. Pat. No. 6,810,254

Tiedemann, Jr., et al. Oct. 26, 2004

Method And Apparatus For Performing Mobile Assisted Hard Handoff Between Communication Systems

U.S. Pat. No. 6,768,726

Dorenbosch, et al. Jul. 27, 2004

Method And Apparatus For Effecting A Seamless Handoff Between IP Connections

U.S. Pat. No. 6,714,785

Han Mar. 30, 2004

Handoff Device And Method For Mobile Communication System

United States Patent Application 20050003821

Sylvain, Dany Jan. 6, 2005

Call Transfer For An Integrated Wireline And Wireless Service

This application describes a method for transitioning a call with a mobile terminal from a cellular connection to a local wireless connection

United States Patent Application 20040233840

Kind Code A1

Bye, Richard A. Nov. 25, 2004

Method For Handoff Of A Telephone Call Between Two Different Wireless Networks

United States Patent Application 20040203788

Kind Code A1

Fors, Chad M.; et al. Oct. 14, 2004

Method And Apparatus For A Target-initiated Handoff From A Source Cellular Wireless Network To A Target Non-Cellular Wireless Network

United States Patent Application 20040264410

Kind Code A1

Sagi, Uday C.; et al. Dec. 30, 2004

Method and apparatus for providing a communication unit with a handoff between networks

This application relates generally to mobile communication units and wireless networks, and, more particularly, to a method and apparatus for providing a handoff for such mobile communication unit between different wireless networks

United States Patent Application 20050136927

Kind Code A1

Enzmann, Markj. Jun. 23, 2005

Method and apparatus for providing seamless call handoff between networks that use dissimilar transmission methods

Method and apparatus for providing seamless call handoff between networks that use dissimilar transmission methods The application relates to wireless communications and, more particularly, to seamlessly handing off a call from one wireless network that uses a particular transmission method to a different wireless network that uses a different transmission method.

United States Patent Application 20050130650

Kind Code A1

Creamer, Thomas E.; et al. Jun. 16, 2005

Cellular to 802.11 voice roaming utilizing SIP signaling

The application relates to the field of cellular communications and, more particularly, to the use of wireless networking in conjunction with cellular networks.

United States Patent Application 20040199637

Kind Code A1

Li, Peng; et al. Oct. 7, 2004

Soft handoff across different networks assisted by an end-to-end application protocol

This application relates generally to soft handoff in communications systems, and more specifically, to soft handoff across different types of communication networks assisted by an end-to-end application protocol.

United States Patent Application 20040246990

Kind Code A1

Krishnamurthi, Govind; et al. Dec. 9, 2004

System and method for handing over a call from a packet-switched network to a circuit-switched network

The system and method of embodiments are capable of handing off such a call in a seamless manner such that the call can be handed off such that the end points of the communication are not aware of the handover and/or do not have to take any specific action to effectuate, or as a result of, the handover. This is quite different from the proposed patent.

United States Patent Application 20050025164

Kind Code A1

Kavanagh, Alan; et al. Feb. 3, 2005

Seamless hand-off of mobile node to a wireless local area network (WLAN)

United States Patent Application 20040264410

Kind Code A1

Sagi, Uday C.; et al. Dec. 30, 2004

Method and apparatus for providing a communication unit with a handoff between networks

This application relates generally to mobile communication units and wireless networks, and, more particularly, to a method and apparatus for providing a handoff for such mobile communication unit between different wireless networks.

United States Patent Application 20050053034

Kind Code A1

Chiueh, Tzi-cker Mar. 10, 2005

System and method for IP handoff

The present disclosure relates to wireless roaming, and more particularly to a system and method for vertical handoff in a wireless network.

United States Patent Application 20050090259

Kind Code A1

Jain, Nikhil; et al. Apr. 28, 2005

Handoff between a wireless local area network and a cellular communication system

This application generally relates to wireless communications. More particularly, the application relates to handoff between a relatively fixed wireless system and a cellular communication system, maintaining all of the billing functionality in the cellular system, whereas the patent is independent of any cellular system.

United States Patent Application 20050245261

Kind Code A1

Ejzak, Richard Paul Nov. 3, 2005

Method of handing off a packet switched to a circuit switched call

The application provides for transferring a packet switched call to a circuit switched call without first terminating the packet switched call. As a result, the transition takes place quickly without requiring the user to manually re-establish the call. This invention has utility in any system that cannot maintain a packet switched call due to unavailability of appropriate network resources whereas circuit switched capability does exist. This refers to an IP wireless call accessing a circuit switched network, which is quite different from the proposed invention.

United States Patent Application 20050265287

Kind Code A1

Lee, Choong-Hun; et al. Dec. 1, 2005

Seamless handoff method in wireless local area network

The application relates to wireless local area networks (WLANs), and in particular, to a seamless handoff method in the WLAN.

United States Patent Application 20050221845

Kind Code A1

Benco, David S.; et al. Oct. 6, 2005

Cordless and cellular communication session handoff

This application specifically involves a wireless cellular base station transfer to a home telephone base station. This does not involve a seamless handoff between a gateway and an IP location.

### DETAILED DESCRIPTION

A user in FIG. 1 of a wireless phone 120 calls and receives all calls through a Gateway 90 which acts as a concentrator and controller for certain features connected probably through the PSTN 100 to the mobile network 110. User 120 has as a home or office location 10 connected through an IP link 50 to an ISP 60. This could actually be any location connected to the IP Network. That local telephone instrument 40 is connected to the local PC 20 via an access device (wireless portable phone also) 30 which converts the phone signals that can dial through the PC into the IP network. These may be analog or digital instruments or a wireless LAN interface. A softphone device on the PC 20 can also be utilized.

The service offered to the user utilizes a server(s) 80 located somewhere on the network communicating to the Gateway 90 and the subscribers of the service, denoted here as location 10 and mobile users 120.

The user 120 can call another user anywhere represented by phone 130 somewhere on the PSTN or possibly another IP phone located at 140. For the patent handoff particulars, when user 120 reaches the facilities of the home or office 10, the mobile phone 120 may be automatically recognized as being in that office, or the user may invoke a manual command via the PC 20 to initiate the handoff. In either case a signal is sent from the PC 20 to the server 80 requesting the handoff, or may be sent from the user wireless device. Server 80 signals the Gateway 90 to initiate the handoff of the wireless leg of the call from the Gateway 90 to the handset 120. There may be audible signals alerting the user of the handoff.

The IP leg from the Gateway 90 to the home or office 10 is activated connected to the PC 20. A softphone in the PC may control the conversation or pass it onward to other devices a applicable. In this example, an analog phone 40 is connected to the PC 20 via a connecting device 30. The user may be requested to initiate the handoff or it may occur automatically.

The conversation from the phone 40 to the other leg of the original call to 130 is now activated and the wireless leg through the wireless network 110 is dropped.

The converse of this may occur where the user at 40 desires to activate their mobile phone 120 in order to leave the premises of 10.

Furthermore, a dual mode wireless device 110 can detect or be detected at a site where an IP leg may be utilized, whereupon the wireless device 110 is utilized rather than switching to another type of device such as a local telephone or softphone device. This type of mode allows different IP locations to be utilized to eliminate the wireless costs based upon the subscriber's login acceptance at these locations.

If the gateway software functions 90 are integrated with the wireless network, say at a base station, then a new form of wireless service and IP service, concentrated on cost savings, can be established with the essence of this invention.

The foregoing description uses preferred embodiments and processes to illustrate the present invention but is not limited to these embodiments. Modifications may be made by those skilled in the art which differ from the specific details disclosed here, but which are still within the scope of the invention.

### DESCRIPTION OF DRAWING

FIG. 1 shows a subscribers home/office location connected to the Internet, a gateway attached to the PSTN and a wireless network with a cellphone.

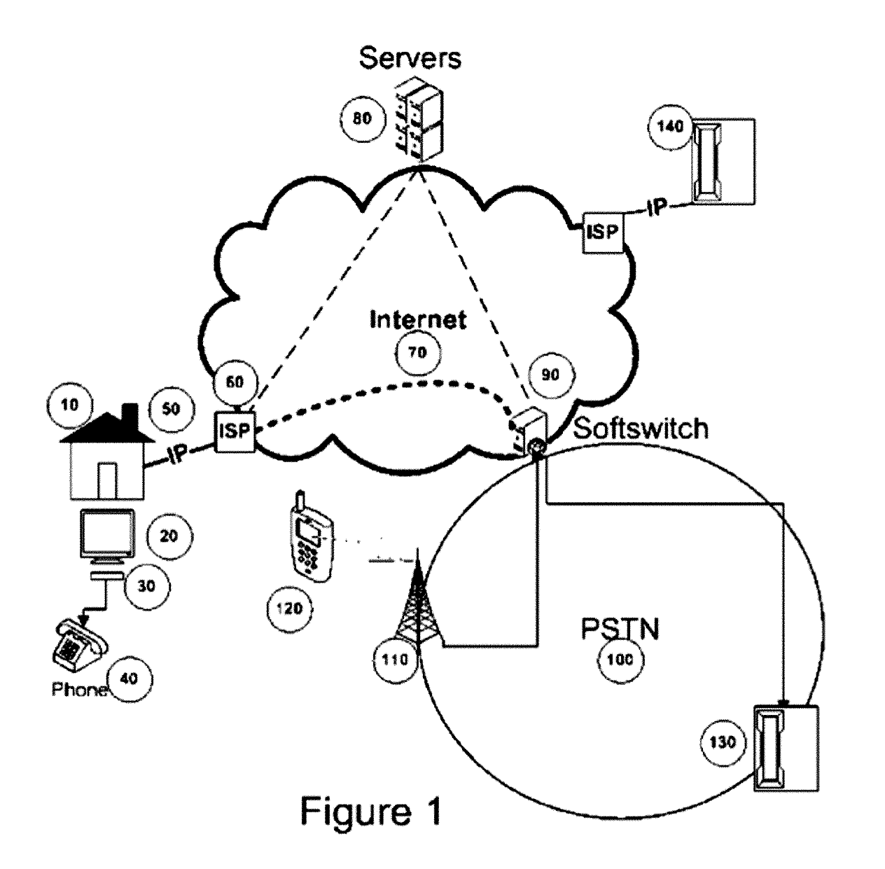

What is claimed is:

1. A method in a subscriber communication system on an IP network, of performing a handoff between a subscriber's wireless leg of a call and a subscriber's IP leg or vice versa, comprising the steps of:
means for storing a subscriber profile with an IP address and a wireless number in a database,
means for connection of said communication system to a plurality of gateways that interface with a plurality of other networks, with said gateways connecting the legs of communication to and from the subscriber,
means for having the wireless leg of a call connected to a gateway
means for determining which subscriber first leg, wireless or IP, is in use,
means for initiating the handoff between the subscriber first and second legs, based upon a plurality of detection techniques,
means for communicating with the receiving second leg device about the handoff,
means for completing the handoff between the subscriber first and second legs, causing the first leg to be dropped, utilizing a plurality of activation techniques.

2. The means of claim 1 where one way of having the wireless leg of a call connected to a gateway is via a PSTN connection.

3. The means of claim 1 where another way of having the wireless leg of a call connected to a gateway is communicatively coupled to the wireless switching center.

4. The means of claim 1 where one way of initiating the handoff is to effect a ring at the receiving second leg device.

5. The means of claim 1 where another way of initiating the handoff is by sending an instant message to the receiving second leg device.

6. The means of claim 1 where another way of initiating the handoff is by sending a short message service to the receiving second leg device.

7. The means of claim 1 where another way of initiating the handoff is by sending a multi-media message service to the receiving second leg device.

8. The means of claim 1 where another way of initiating the handoff is by sending a DTMF signal to the receiving second leg device.

9. The means of claim 1 where one activation technique is allowing manual activation of the handoff event initiated from first leg device.

10. The means of claim 1 where one way of completing the handoff between the subscriber two legs is by an automated technique.

11. The means of claim 1 where another way of completing the handoff is by a confirmation method with the subscriber agreeing to the handoff.

12. The means of claim 1 allowing the subscriber to change their IP address so as to effect the handoff utilizing a different IP address leg.

13. The means of claim 1 where a dual mode wireless device is used by the subscriber that connectively communicates to the IP leg end point system in a plurality of ways, whereupon the subscriber does not have to change the telephone type device when the handoff is completed.

14. The means of claim 1 when a subscriber device is logged into a remote site, for example hotels, office buildings, a home, coffee shops, hotspots and the like, the subscriber device communicates to the subscriber communication system to forward subscriber communications to the new location while the subscriber is logged in.
